(19) United States
(12) Patent Application Publication
(10) Pub. No.: US 2010/0180720 A1
(43) Pub. Date: Jul. 22, 2010

(54) MOTOR MODULE FOR ATTACHMENT TO A TRANSMISSION HOUSING OF A MODULAR TRANSMISSION ASSEMBLY

(75) Inventors: Gregory W. Kempf, Avon, IN (US); William S. Reed, Greenfield, IN (US); Timothy J. Reinhart, Brownsburg, IN (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/355,859

(22) Filed: Jan. 19, 2009

(51) Int. Cl. F16H 57/02; H02K 5/04

(52) U.S. Cl. 74/606 R; 310/89; 903/915; 903/952

(57) ABSTRACT

A motor module is configured for attachment to a transmission housing of a modular transmission assembly. The motor module includes a motor and a support structure. The motor is configured for rotation about a central axis and extends between a first end and a second end. The support structure is operatively connected to the motor such that the support structure at least partially supports the motor. The support structure at least partially extends across the second end of the motor. The support structure is configured for internal attachment to the housing.

### TECHNICAL FIELD

The present invention relates to a motor module for attaching to a transmission housing of a modular transmission assembly.

### BACKGROUND OF THE INVENTION

A transmission assembly may include one or more motors that are assembled within a transmission housing. The motors may further include a rotor and a stator. These transmission assemblies are typically assembled piecemeal within the transmission housing. This means that the rotors and stators of the motors are individually inserted into the transmission housing. The fully assembled transmission assembly is then tested to ensure that the transmission assembly, including each of the motors, operates properly.

### SUMMARY OF THE INVENTION

A motor module is configured for internal attachment to a transmission housing of a modular transmission assembly. The motor module includes a motor and a support structure. The motor is configured for rotation about a central axis and extends between a first end and a second end. The support structure is operatively connected to the motor such that the support structure at least partially supports the motor. The support structure at least partially extends across the second end of the motor. The support structure is configured for internal attachment to the transmission housing.

A modular transmission assembly includes a transmission housing and a motor module. The transmission housing defines a hollow interior. The motor module includes a motor, a rear stator housing, and a bearing support. The motor is configured for rotation about a central axis. The rear stator housing radially surrounds the motor about the central axis. The bearing support radially surrounds the central axis. The rear stator housing and the bearing support define a joint therebetween such that the rear stator housing and the bearing support are operatively connected. The rear stator housing is configured for operative internal attachment to the transmission housing such that the motor module is at least partially supported by the transmission housing.

A motor module for a modular transmission assembly includes a rear rotor, a rear stator, a rear stator housing, and a bearing support. The rear rotor is configured for rotation about a central axis. The rear stator radially extends about the rear stator and the central axis. The rear stator housing radially surrounds the rear stator about the central axis. The bearing support radially surrounds the central axis. The rear rotor radially surrounds the rear bearing support. The rear stator housing and the bearing support define a joint therebetween such that the rear stator housing and the bearing support are operatively connected. The bearing support presents a connection region that is configured for internal attachment to a mounting flange within the modular transmission assembly.

By assembling the motor module as a single component for internal attachment to the modular transmission assembly, the number of individual components that need to be assembled within and attached to the transmission housing is reduced. Additionally, the motor module may be bench tested prior to assembly into the transmission assembly to ensure that the motor module functions properly. This may reduce the amount of time that it takes to assemble the modular transmission assembly. This prevents the assembled modular transmission from having to be disassembled if one of the modules is not functioning properly. In addition, by assembling the motor module as a single module, metal shavings and other types of contaminants may be prevented from entering the assembled modular transmission. When the motor module is attached directly to the mounting flange, inside the transmission housing, additional housing stiffness is provided to reduce housing vibration and thereby externally radiated noise. Attaching the end of the motor module to the mounting flange eliminates a need for radial connecting ears while allowing a diametrical motor size of the motor module to be maximized within the transmission housing.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

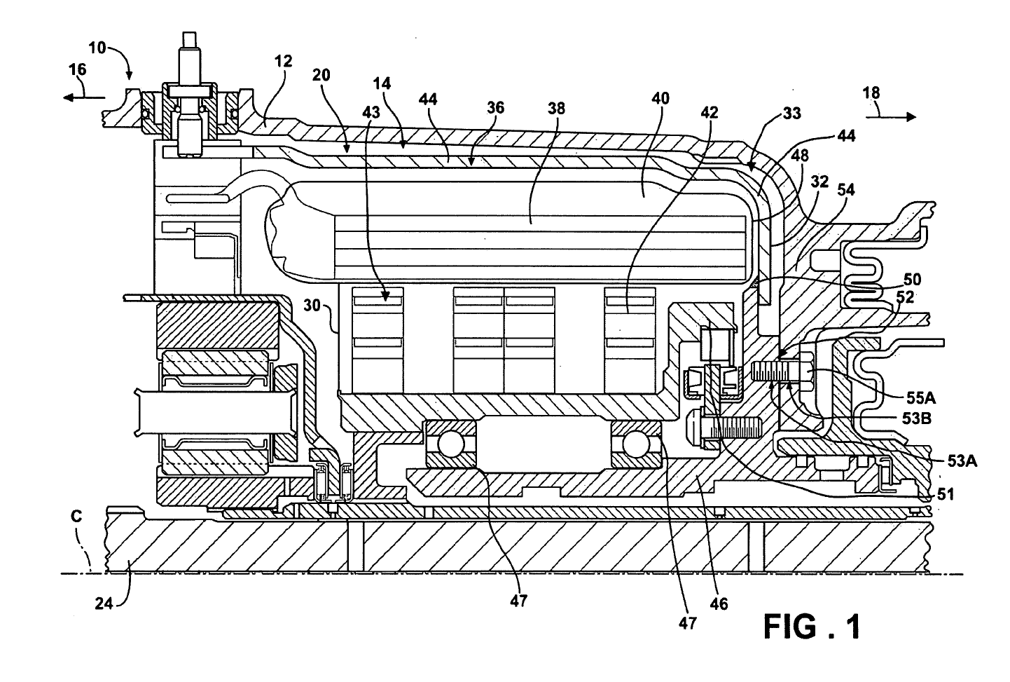

Referring now to the FIG. 1, FIG. 1 is a schematic partial cross sectional view of a motor module of a modular transmission assembly.

### DESCRIPTION OF THE PREFERRED EMBODIMENTS

Referring to the drawings, wherein like reference numbers refer to like components, FIG. 1 shows a modular transmission assembly 10 for connection to an engine (not shown) of a vehicle (not shown). The modular transmission assembly 10 includes a transmission housing 12 that defines a hollow interior 14 extending along a central axis C between a front end 16 and a rear end 18. The front end 16 of the transmission housing 12 generally corresponds to an input (not shown) into the modular transmission assembly 10 from an engine. The rear end 18 of the transmission housing 12 corresponds to an output from the modular transmission assembly 10 to drive wheels (not shown) of the vehicle.

A motor module 20 is disposed in, and is operatively connected to, the transmission housing 12, as shown in FIGS. 1 and 2. A main shaft 24 is disposed along the central axis C for rotation about the central axis C. The motor module 20 radially surrounds the main shaft 24. A front motor stator assembly 26 is disposed in the transmission housing 12. The front motor stator assembly 26 radially surrounds the main shaft 24. The inner module 22 is axially disposed along the central axis C between the motor module 20 and the front motor stator assembly 26. An input module 28 is connected to the front end 16 of the transmission housing 12, as shown in FIGS. 1 and 4. The front motor stator assembly 26 is axially disposed along the central axis C between the inner module 22 and the input module 28.

Referring to FIG. 1, the motor module 20 extends between a first end 30 and a second end 32. The motor module 20 includes a motor 36. The motor 36 may be an electric motor or any other motor known to those skilled in the art. The motor 36 may include a plurality of permanent magnets 38. The motor 36 may include a rear stator 40. The motor 36 may also include a rear rotor 42 for rotation relative to the rear stator 40 about the central axis C. The rear stator 40 defines a central opening 43 with the central axis C extending through the central opening 43. The rear rotor 42 may be disposed in the central opening 43 such that the rear stator 40 radially surrounds the rear rotor 42.

The motor module 20 includes a support structure 33 that is operatively connected to the motor 36 such that the support structure 33 at least partially supports the motor 36. The support structure 33 at least partially extends across the second end 32 of the motor 36. The support structure 33 is configured for internal attachment to the transmission housing 12, as will be explained in more detail below. The support structure 33 may include a rear stator housing 44 and a bearing support 46. The rear stator housing 44 radially surrounds the motor 36. More specifically, the rear stator housing 44 radially surrounds the rear stator 40 such that the rear stator 40 is operatively connected to the rear stator housing 44. The bearing support 46 radially surrounds the main shaft 24 about the central axis C. The bearing support 46 is radially surrounded by the motor 36. More specifically, the bearing support 46 is radially surrounded by the rear rotor 42. The rear stator housing 44 and the bearing support 46 extend axially along the central axis C and at least partially extend about an end 48 of the motor 36, proximate the second end 32 of the motor module 20.

The rear stator housing 44 and the bearing support 46 come together across the end 48 of the motor 36 and a joint 50 is defined therebetween. The joint 50 may be formed by welding, fastening, and the like. Therefore, by joining the rear stator housing 44 and the bearing support 46, the rear stator housing 44, and the bearing support 46, provide a unitary construction to contain and support all of the components of the motor 36 therein. Connection of the bearing support 46 retains the motor module 20 within the transmission housing 12. A connection region 52 is defined in the bearing support 46 at the second end 32 of the motor module 20. The connection region 52 may define a hole 53A that is configured to connect the motor module 20 as a single unit to a mounting flange 54 of the transmission housing 12 via at least one fastener 55A. More specifically, the mounting flange 54 may define a hole 53B. Therefore, that the fastener 55A extends through each of the holes 53A, 53B, and threadedly engages at least one of the holes 53A, 53B, to retain the motor module 20 to the mounting flange 54 of the transmission housing 12. It should be appreciated, however, that the invention is not limited to using fasteners 55A at the connection region 52, as any other connector known to those skilled in the art may also be used. In addition, the connection region 52 may be used to mount the motor module 20 on a test stand (not shown) prior to assembly to the transmission housing 12 to verify the motor 36 disposed within the motor module 20 operates properly.

Additionally, a rotor support 51 may be radially disposed between the rear rotor 42 and the bearing support 46. The rear rotor 42 may be operatively connected to the rotor support 51. At least one bearing 47 is disposed radially between each of said rotor support 51 and the bearing support 46. The bearings 47 facilitate rotation of the rear rotor 42 and the rotor support 51 about the central axis C, relative to each of the bearing support 46, the rear stator 40, and the rear stator housing 44.

To assemble the modular transmission assembly 10, the motor module 20 is oriented such that the second end 18 is facing generally upward, relative to the ground. The front end 16 of the transmission housing 12 may be oriented such that the front end 16 is facing generally downward, relative to the ground, and the front end 16 of the transmission housing 12 is slid over the second end 32 of the motor module 20. Therefore, after transmission housing 12 is slid over the motor module 20, the first end 30 of the motor module 20 faces the front end 16 of the transmission housing 12 and the second end 32 of the motor module 20 faces the rear end 18 of the transmission housing 12. While the front end 16 of the transmission housing 12 is facing generally downward, relative to the ground, the rear end 18 of the transmission housing 12 is facing generally upward, relative to the ground. At least one fastener 55A may then be inserted through the mounting flange 54 of the transmission housing 12 and the second end 32 of the motor module 20 via the rear end 18 of the transmission housing 12 to retain the motor module 20 to the transmission housing 12. The fasteners 55A may be attached about the transmission housing 12 to form a bolt circle or any other pattern to sufficiently secure the motor module 20 to the transmission housing 12. As described above the fastener 55A would extend through the bearing support 46 of the motor module 20. The motor module 20 may then be attached to the mounting flange 54 within the transmission housing 12 via one or more fasteners 55A.

The main shaft 24 may be inserted in the front end 16 of the transmission housing 12, along the central axis C, such that the main shaft 24 extends through the motor module 20.

While the best modes for carrying out the invention have been described in detail, those familiar with the art to which this invention relates will recognize various alternative designs and embodiments for practicing the invention within the scope of the appended claims.

1. A motor module for internal attachment to a transmission housing of a modular transmission assembly, said motor module comprising:
a motor configured for rotation about a central axis and extending between a first end and a second end; and
a support structure operatively connected to said motor such that said support structure at least partially supports said motor;
wherein said support structure at least partially encloses said second end of said motor;
wherein said support structure is configured for internal attachment to the transmission housing.

2. A motor module, as set forth in claim 1, wherein said motor includes a rear stator and a rear rotor configured for rotation relative to said rear stator about said central axis.

3. A motor module, as set forth in claim 2, wherein said rear stator defines a central opening and said central axis extends through said central opening.

4. A motor module, as set forth in claim 3, wherein said rear stator is disposed in said central opening such that said rear stator radially surrounds said rear rotor.

5. A motor module, as set forth in claim 4, wherein said support structure includes:
a rear stator housing radially surrounding said rear stator;
a bearing support at least partially disposed in said central opening such that said bearing support is at least partially radially surrounded by said rear rotor;
wherein each of said rear stator housing and said bearing support at least partially enclose said second end of said motor.

6. A motor module, as set forth in claim 5, wherein said support structure further includes a joint defined between said rear stator housing and said bearing support, proximate said second end, to at least partially support each of said rear stator and said rear rotor.

7. A motor module, as set forth in claim 6, wherein said bearing support is configured for connection to the transmission housing such that said motor is at least partially supported by the transmission housing.

8. A motor module, as set forth in claim 5, further comprising a rotor support radially disposed between said rear rotor and said bearing support, wherein said rear rotor is operatively connected to said rotor support.

9. A motor module, as set forth in claim 8, further comprising at least one bearing radially disposed between each of said rotor support and said bearing support to facilitate rotation of said rear rotor and said rotor support about said central axis, relative to each of said bearing support, said rear stator, and said rear stator housing.

10. A motor module, as set forth in claim 1, wherein said motor defines a central opening and said central axis extends through said central opening.

11. A motor module, as set forth in claim 10, wherein said support structure extends at least partially into said central opening.

12. A modular transmission assembly comprising:
a transmission housing defining a hollow interior; and
a motor module including;
a motor configured for rotation about a central axis,
a rear stator housing radially surrounding said motor about said central axis,
a bearing support radially surrounding said central axis,
wherein said rear stator housing and said bearing support define a joint therebetween such that said rear stator housing and said bearing support are operatively connected;
wherein said rear stator housing is configured for operative internal attachment to said transmission housing such that said motor module is at least partially supported by said transmission housing.

13. A modular transmission assembly, as set forth in claim 12, wherein said transmission housing includes a mounting flange extending into said hollow interior and said rear stator housing is configured for operative internal attachment to said mounting flange such that said motor module is at least partially supported by said mounting flange.

14. A modular transmission assembly, as set forth in claim 13, wherein said rear stator housing presents a connection region configured for internal attachment to said mounting flange.

15. A modular transmission assembly, as set forth in claim 14, wherein each of said rear stator housing and said mounting flange define a hole configured for internally attaching said motor module to said mounting flange.

16. A modular transmission assembly, as set forth in claim 15, further comprising a fastener configured to extend through said holes of each of said rear stator housing and said mounting flange such that said motor module is at least partially supported by said mounting flange.

17. A motor module for a modular transmission assembly, said motor module comprising:
a rear rotor configured for rotation about a central axis;
a rear stator radially extending about said rear stator and said central axis;
a rear stator housing radially surrounding said rear stator about said central axis; and
a bearing support radially surrounding said central axis;
wherein said rear rotor radially surrounds said rear bearing support;
wherein said rear stator housing and said bearing support define a joint therebetween such that said rear stator housing and said bearing support are operatively connected;
wherein said bearing support presents a connection region configured for internal attachment to a mounting flange within the modular transmission assembly.

18. A motor module, as set forth in claim 13, wherein said connection region defines at least one hole configured for internal attachment to the mounting flange within the modular transmission assembly.
